(19) United States
(12) Patent Application Publication
(10) Pub. No.: US 2012/0267826 A1
(43) Pub. Date: Oct. 25, 2012

(54) MOLD FOR PRODUCING MICROPRODUCT AND METHOD OF PRODUCING MICROPRODUCT

(75) Inventor: Makoto SAKAI, Toyama-shi (JP)

(73) Assignee: RICHELL CORPORATION, Toyama-shi (JP)

(21) Appl. No.: 13/543,420

(22) Filed: Jul. 6, 2012

Related U.S. Application Data
(63) Continuation of application No. PCT/JP2010/069551, filed on Nov. 4, 2010.

(30) Foreign Application Priority Data
Jan. 7, 2010 (JP) 2010-002172

(51) Int. Cl. B29C 59/02

(52) U.S. Cl. 264/293; 425/385

(57) ABSTRACT

A mold for producing a microproduct includes a first mold on which a stamper member is disposed, and a second mold that relatively moves with respect to the first mold. The first mold includes a frame and a base mold. The base mold includes a back side section that supports the back side of the stamper member. The frame includes a front side restriction section that is positioned opposite to the front side edge area of the stamper member, and a sidewall that is positioned opposite to the side of the stamper member. A given clearance is provided between the front side edge area of the stamper member and the front side restriction section of the frame and/or between the side of the stamper member and the sidewall of the frame.

### CROSS REFERENCE TO RELATED APPLICATIONS

This application is a continuation of International Patent Application No. PCT/JP2010/069551, having an international filing date of Nov. 4, 2010, which designated the United States, the entirety of which is incorporated herein by reference. Japanese Patent Application No. 2010-002172 filed on Jan. 7, 2010 is also incorporated herein by reference in its entirety.

### BACKGROUND

The present invention relates to a mold that is used to precisely transfer a microstructure formed on the surface of a stamper member to a resin molding material, and a method of producing a microproduct using the mold.

When producing a microproduct having a surface microstructure, a stamper member having a given microstructure formed on its surface is disposed in a cavity of a mold, and a resin material is injected into the mold to transfer the microstructure of the stamper member to the resin material.

It is known in the art to utilize a metal stamper member to which a microstructure of a master die is transferred by electroforming or the like. However, the size and the precision of a microstructure obtained by electroforming are limited.

In order to obtain a more precise microstructure, attempts have been made to produce a stamper member using a single-crystal material (e.g., silicon or quartz), a ceramic material (e.g., silicon carbide, silicon dioxide, or alumina), or a silicon-on-insulator (SOI) wafer that includes an insulating film.

For example, JP-A-2001-158031 discloses technology that utilizes a stamper member made of silicon.

However, a single-crystal material and a ceramic material are brittle, and easily break. Therefore, a stamper member may break when disposing the stamper member in the mold, or transferring the microstructure of the stamper member to a resin material injected into the mold (i.e., the stamper member has a very short lifetime).

Even if the stamper member can be disposed in the mold without breakage, the stamper member may break due to several to several tens of shots of injection molding (i.e., it is not suitable for mass production).

The stamper member is normally secured on the mold using an adhesive (see JP-A-2001-158031, for example). However, since the bonding accuracy of the back side of the stamper member may be insufficient when molding a micrometer-sized microstructure (e.g., microproduct), the resulting molded product may have insufficient dimensional accuracy.

Moreover, skill is required to secure the stamper member on the mold using an adhesive, and on-site replacement work takes time.

### SUMMARY

The invention may provide a mold for producing a microproduct that exhibits an excellent transfer capability using a stamper member, produces a molded product having excellent dimensional accuracy, and is effective for increasing the lifetime of the stamper member, and a method of producing a microproduct using the same.

The invention also aims at improving the mass-producibility of microproducts, and improving workability when disposing a stamper member in a mold.

According to one aspect of the invention, there is provided a mold for producing a microproduct comprising:

a first mold on which a stamper member is disposed; and

a second mold that is disposed to be relatively opened and closed with respect to the first mold,

the first mold including a frame and a base mold,

a front side of the stamper member, the frame, and the second mold defining a cavity,

the base mold including a back side section that supports a back side of the stamper member,

the frame including a front side restriction section that is positioned opposite to a front side edge area of the stamper member, and a sidewall that is positioned opposite to a side of the stamper member, and

a given clearance being provided between the front side edge area of the stamper member and/or the front side restriction section of the frame or between the side of the stamper member and the sidewall of the frame.

Note that the given clearance is a space that prevents a situation in which the front side edge area and/or the side of the stamper member comes in pressure contact with the frame. The clearance is preferably 0.001 to 0.1 mm. It is more preferable that the clearance between the front side edge area of the stamper member and the front side restriction section of the frame be 0.005 to 0.05 mm, and the clearance between the side of the stamper member and the sidewall of the frame be 0.03 to 0.07 mm.

In the mold, the back side section of the base mold of the first mold may be a protrusion section that is surrounded by a groove, and

the sidewall of the frame may be disposed in the groove so that a bottom of the sidewall comes in contact with a bottom of the groove.

The frame may be fastened to the base mold using only bolts (see FIG. 11), for example. Note that the following advantages are obtained by forming the groove around the back side section of the first mold.

Specifically, the frame can be positioned easily and stably by causing the bottom of the sidewall of the frame to come in contact with the bottom of the groove.

Moreover, the frame can be easily replaced.

When the frame is fastened to the base mold using only bolts, the bolts may loosen during molding due to an impact applied when opening or closing the mold, so that the frame may be displaced, or may fall due to breakage of the bolts.

The above mold structure is particularly effective when the stamper member is formed of a brittle material that easily breaks.

The stamper member may be produced using single-crystal silicon, and may be a silicon stamper or an SOI wafer that has a given microstructure formed on its surface.

The silicon stamper is suitable when precisely forming microelevations/microdepressions or microgrooves in its surface using a photoresist and an etching process, for example.

The SOI wafer has a three-layer structure in which a silicon wafer, an SiO₂ layer, and a silicon wafer are sequentially stacked.

When forming micrometer-sized elevations and depressions on the surface of the SOI wafer, a resist pattern is formed on the surface of the SOI wafer as a mask, and the silicon wafer is etched using the Bosch process.

In this case, the silicon wafer is etched at high speed, while the SiO₂ layer is etched to only a small extent.

Therefore, the etching process ends when the silicon wafer has been etched in the thickness direction until the SiO₂ layer is exposed.

Specifically, the SiO₂ layer functions as an etching stopper, and the height of elevations and depressions depends on the thickness of the silicon wafer. Therefore, elevations and depressions can be formed with very high precision.

When using a single-layer silicon wafer, the height of elevations and depressions is controlled by adjusting the thickness of the resist pattern formed on the surface of the silicon wafer, the dry etching time, and the like. In this case, however, it is difficult to obtain elevations and depressions with high precision and high reproducibility (i.e., a variation in height of elevations and depressions occurs).

For example, an error of ±0.5 μm may occur when it is desired to form a groove having a depth of 4 μm (i.e., a variation of ±12.5% occurs in the height direction), so that the detection accuracy of the detection system may significantly deteriorate.

The stamper member may also be produced using quartz, silicon carbide, silicon dioxide, alumina, or the like.

The productivity is improved by injection-molding or transfer-molding a thermoplastic resin material using the above mold. This contributes to a reduction in cost of the microproduct.

The term “microproduct” used herein includes various microproducts having a microstructure that are used in various fields such as medical treatment, biochemistry, electrochemistry, electrical engineering, and analytical chemistry. Examples of the microproduct include a microarray, a microTAS, a microreactor, and the like.

The term “microarray” used herein refers to a microchip in which microdepressions having a dimension of several to several tens of micrometers (e.g., 5 to 90 μm) are arrayed. The term “microTAS” used herein refers to a microchip in which biochemical processes and biochemical detection are integrated (miniaturized) on a single chip by forming a network of microchannels in which liquid solution or gas flows on a substrate.

The term “microreactor” used herein refers to a microchip that makes it possible to implement mixing, reactions, separation, and the like for chemical reactions or material production utilizing a phenomenon within a microspace (microchannel) having a dimension of several to several hundreds of micrometers (e.g., 5 to 200 μm). In recent years, the microreactor has been increasingly used in the field of electrochemistry (e.g., fuel cell) in addition to the fields of medical treatment and analytical chemistry.

The thermoplastic material that may be used in one aspect of the invention is not particularly limited.

Examples of the thermoplastic material include a polypropylene-based resin, a polyester-based resin, a polysulfone-based resin, a polyvinyl chloride-based resin, a polystyrene-based resin, a silicone resin, a polyolefin-based resin, a polymethacrylate resin, a fluorine-containing resin, and the like.

A polypropylene homopolymer or a polypropylene random copolymer that includes an α-olefin (e.g., ethylene, butene-1, or hexene-1) may be used as the polypropylene-based resin.

Examples of a thermoplastic elastomer include a polystyrene-based thermoplastic elastomer and a polyolefin-based thermoplastic elastomer. Examples of the polystyrene-based thermoplastic elastomer include a polymer block that includes one or more aromatic vinyl compounds selected from styrene, α-methylstyrene, o-methylstyrene, m-methylstyrene, p-methylstyrene, 2,4-dimethylstyrene, vinylnaphthalene, and vinylanthracene as a monomer unit.

Examples of the polyolefin-based thermoplastic elastomer include copolymers of ethylene and an α-olefin having 3 to 10 carbon atoms.

A nonconjugated diene may be polymerized in the thermoplastic elastomer.

A material obtained by mixing a hydrogenated styrene-butadiene-based block copolymer or a hydrogenated styrene-based copolymer into homopolypropylene is suitable for producing a microproduct.

In particular, a material obtained by mixing a polypropylene-based resin and a thermoplastic elastomer is preferable when producing a microproduct. It is preferable to adjust the size of the clearance of the mold according to one aspect of the invention depending on the viscosity of the material and the injection molding conditions.

According to one aspect of the invention, since a given clearance is provided between the front side edge area of the stamper member and the front side restriction section of the frame and/or between the side of the stamper member and the sidewall of the frame when restricting the movement of the stamper member using the frame in a state in which the back side of the stamper member is supported by the back side section (protrusion section) of the base mold of the first mold, it is possible to prevent a situation in which an impact is applied directly to the stamper member due to the frame when disposing the stamper member in the mold, or when precisely transferring the microstructure to the resin material.

When a given clearance a is provided between the front side edge area of the stamper member and the front side restriction section of the frame, and a given clearance b is provided between the side of the stamper member and the sidewall of the frame, it is possible to prevent a situation in which a difference in amount of expansion occurs between the frame, the base mold, and the stamper member due to a difference in quantity of heat applied from the resin material during molding or a difference in coefficient of thermal expansion between the frame, the base mold, and the stamper member, so that the stamper member is pressed by the frame and the base mold, and breaks.

This increases the lifetime of the stamper member, so that the production cost can be reduced.

Since the stamper member can be disposed in the mold without using an adhesive by restricting the movement of the stamper member using the frame, the stamper member can be easily replaced.

The viscosity of the material changes when changing the type of the resin material, or changing the mixing ratio of a polypropylene-based resin and a thermoplastic elastomer (e.g., 80:20, 50:50, or 30:70). In this case, the resin material may form a burr when the clearance a between the frame and the stamper member is large, or short shot or burning may occur due to insufficient breathing when the clearance a between the frame and the stamper member is small. According to one aspect of the invention, since the clearance a can be easily adjusted on site, it is possible to promptly deal with such problems.

Therefore, it is possible to easily deal with a change in ambient temperature, material lot, material grade, or molding machine.

### BRIEF DESCRIPTION OF THE DRAWINGS

FIG. 1 is a cross-sectional view illustrating the configuration of a mold according to one embodiment of the invention.

FIG. 2 is a view illustrating a state in which a first mold and a second mold are closed to form a cavity.

FIG. 3 is a view illustrating a state in which a resin material is injection-molded.

FIG. 4 is a view illustrating a state in which a microproduct is removed from a mold.

FIG. 5 is a view illustrating the clearance between a stamper member and a frame.

FIG. 6 is an exploded perspective view illustrating a mold.

FIG. 7 is a view illustrating an example of a microproduct having microdepressions.

FIG. 8 is a view illustrating an example of a microproduct having a microchannel.

FIG. 9 is a view illustrating an example of a mold that does not have a groove.

FIG. 10 is a view illustrating an example in which a second mold is flat.

FIG. 11 is a view illustrating an example in which an L-shaped groove is formed around a back side section of a base mold of a first mold.

FIG. 12 is a view illustrating an example in which a clearance is adjusted using a liner.

FIG. 13 is a view illustrating an example in which a clearance is adjusted by replacing a protrusion section.

### DESCRIPTION OF EXEMPLARY EMBODIMENTS

Examples of the structure of a mold according to several embodiments of the invention are described below with reference to the drawings. Note that the structure of the mold is not limited thereto.

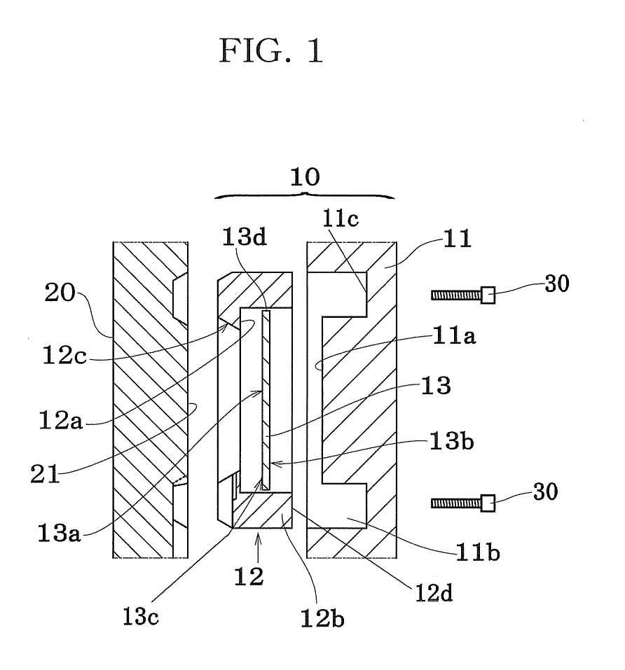

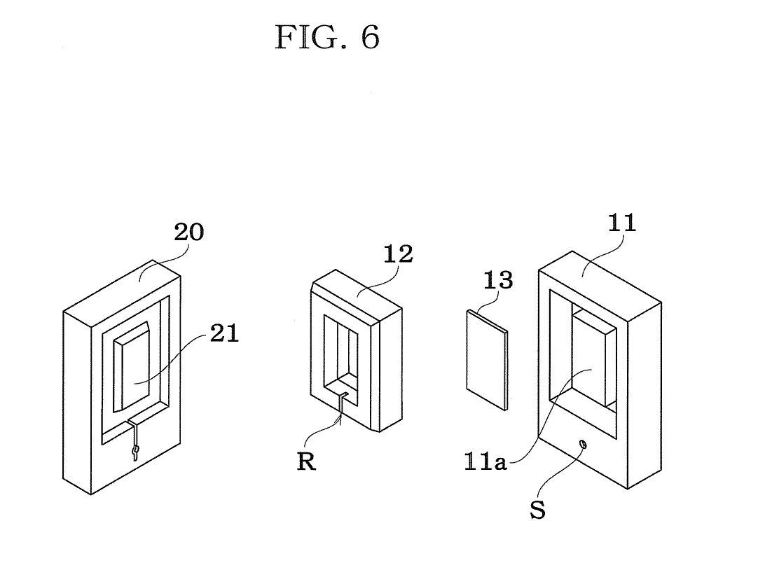

FIG. 1 is a cross-sectional view illustrating the configuration (arrangement) of the mold, and FIG. 6 is a perspective view illustrating the external appearance of the mold.

A second mold 20 relatively moves forward and backward (i.e., makes a closing motion and an opening motion) with respect to a first mold 10.

In one embodiment of the invention, the first mold 10 includes a base mold 11, a stamper member 13, and a frame 12.

The base mold 11 includes a back side section (protrusion section) 11a that supports a back side 13b of the stamper member 13. The base mold 11 may have a groove 11b that is formed around the protrusion section 11a.

The frame 12 includes a front side restriction section 12a that is positioned opposite to a front side edge area 13c of a front side (i.e., a side opposite to a product) 13a of the stamper member 13, and a sidewall 12b that extends from the front side restriction section 12a in a frame-like shape, and has an approximately L-shaped cross section.

The frame 12 is fitted into the base mold 11 in a state in which the back side 13b of the stamper member 13 is supported by the back side section 11a of the base mold 11.

Note that a bottom 12d of the sidewall 12b of the frame 12 may be fastened to a bottom 11c of the groove 11b of the base mold 11 using bolts 30, for example.

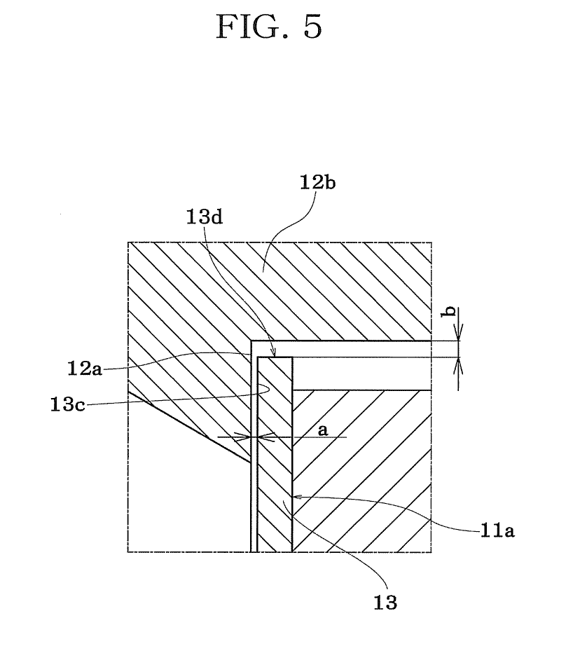

The dimensions of the frame 12 and the base mold 11a are designed so that clearances a and b (see FIG. 5 (enlarged view)) are formed in a state in which the bottom 12d of the sidewall 12b of the frame 12 comes in contact with the bottom 11c of the groove 11b. The clearance a is formed between the front side restriction section 12a of the frame 12 and the front side edge area 13c of the stamper member 13. The clearance b is formed between a side 13d of the stamper member 13 and the sidewall 12b of the frame 12.

The clearance a or b may be zero (a=0 or b=0), but both the clearances a and b should not be zero.

If both the clearances a and b are zero (a=b=0), the stamper member 13 may easily break when positioning the stamper member 13 between the frame 12 and the base mold 11. Even if the stamper member 13 can be positioned between the frame 12 and the base mold 11 without breakage, the frame 12 and the base mold 11 may thermally expand due to heat applied by a resin material when molding a microproduct, and may interfere with the stamper member 13, so that the stamper member 13 may easily break.

When disposing a brittle stamper member in the mold, the stamper member may break even if the machining error of the mold and the dimensional error of the stamper member are within an allowable range for normal injection molding.

The clearance a is preferably 0.003 to 0.10 mm, and more preferably 0.005 to 0.05 mm.

If the clearance a is less than 0.003 mm, the stamper member may easily break. If the clearance a exceeds 0.10 mm, it may be likely that a resin (e.g., burr) enters the clearance a.

It is also necessary to take account of the effects of the roughness of the finished surface of the front side restriction section 12a of the frame 12. The parallelism of the finished surface of the front side restriction section 12a in the direction in which the front side restriction section 12a overlaps the front side edge area 13c of the stamper member 13 is preferably 0.005 mm or less.

It is preferable that the back side section (protrusion section) 11a of the base mold 11 that supports the stamper member 13 have a JIS surface roughness Rz of 1 μm or less and a parallelism of 0.005 mm or less. Since the depth of the groove 11b also affects the clearance a, it is important to finish the groove 11b so that a given clearance is formed.

It is preferable that the bottom 11c of the groove 11b that receives (supports) the frame 12, and the bottom 12d of the sidewall 12b of the frame 12, also have a JIS surface roughness Rz of 1 μm or less and a parallelism of 0.005 mm or less.

It may be necessary to adjust the clearance a depending on the type of resin material and the mixing ratio of polypropylene and a thermoplastic elastomer.

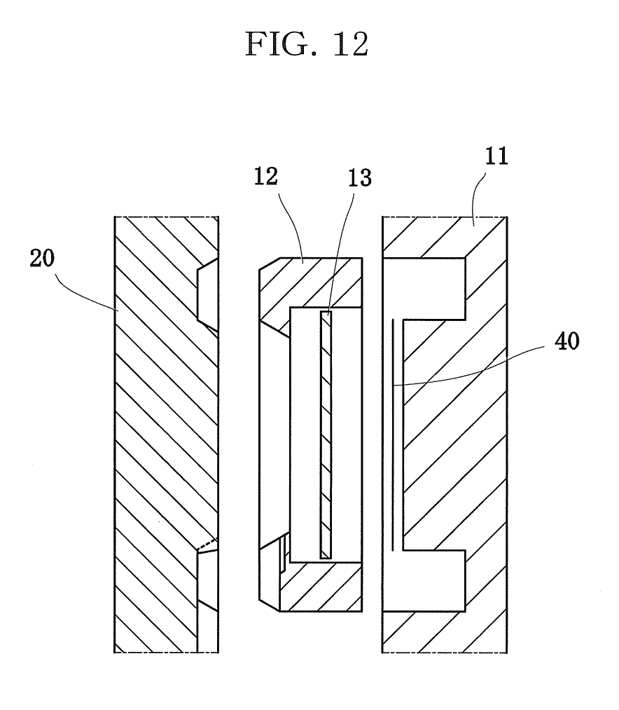

In this case, a liner 40 (see FIG. 12) having a given thickness may be disposed on the back side of the stamper member 13, and the thickness of the liner 40 may be gradually changed until a burr does not occur, for example.

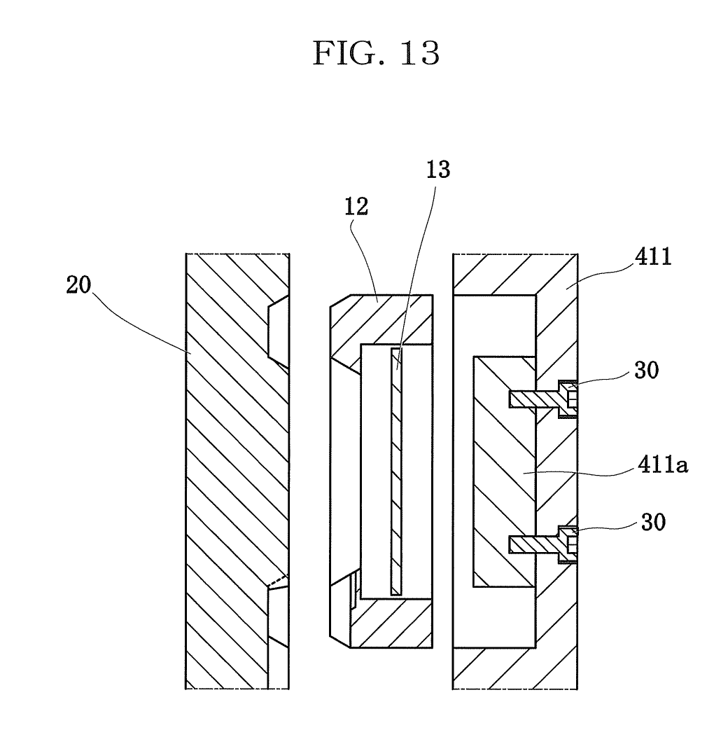

Alternatively, a plurality of nested mold members 411a (see FIG. 13) that differ in height by 0.01 mm may be provided as the protrusion section of a base mold 411 of the first mold, and may be exchanged so that the clearance is optimized.

The clearance b is preferably 0.01 to 0.1 mm, and more preferably 0.03 to 0.07 mm.

If the clearance b is less than 0.01 mm, the stamper member 13 may easily break. If the clearance b exceeds 0.1 mm, the stamper member 13 may be easily displaced along the back side section 11a, so that the dimensional accuracy of the precisely transferred product with respect to the reference plane (surface) may vary.

Note that the clearance b formed around the side 13d of the stamper member 13 need not necessarily be adjusted around the entire inner side of the sidewall 12b of the frame 12 (e.g., the side 13d of the stamper member 13 may be supported by one or more protrusions opposite to the side 13d).

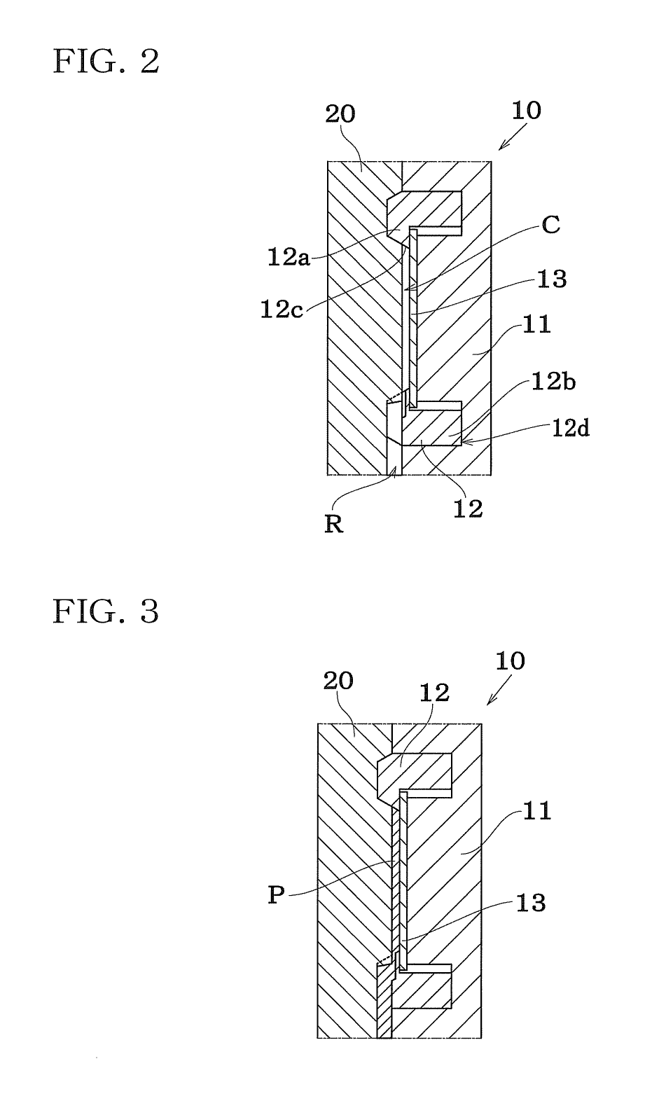

A cavity C is formed by the front side 13a of the stamper member 13, the frame 12, and a cavity side 21 of the second mold 20 (see FIG. 2 (cross-sectional view)) by disposing the second mold 20 on the first mold 10.

A resin is injection-molded via a sprue S and a runner R to obtain a microproduct P (see FIG. 3).

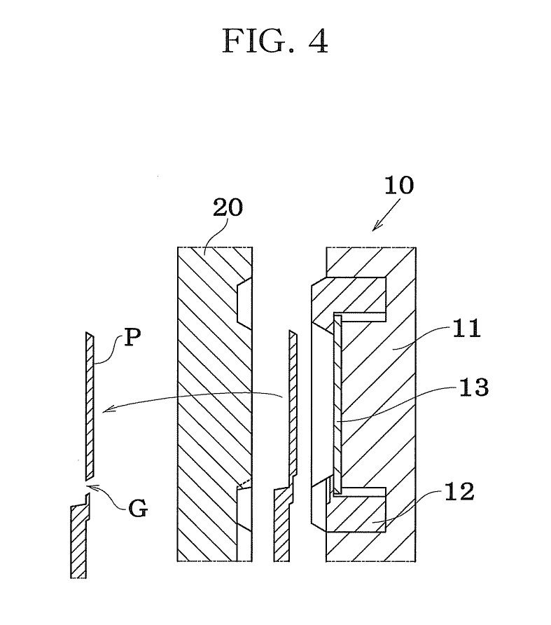

As illustrated in FIG. 4, the microproduct P is removed from the mold, and cut at a gate G.

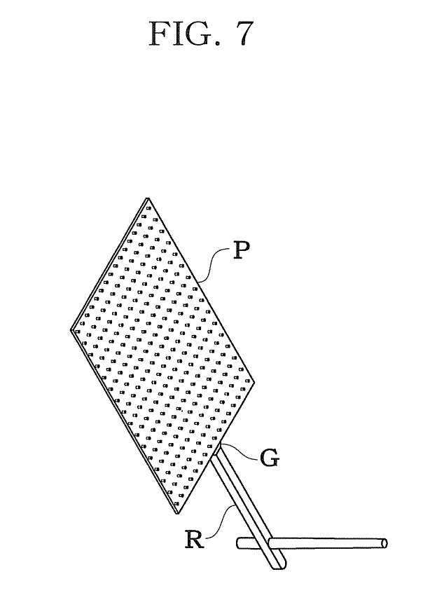

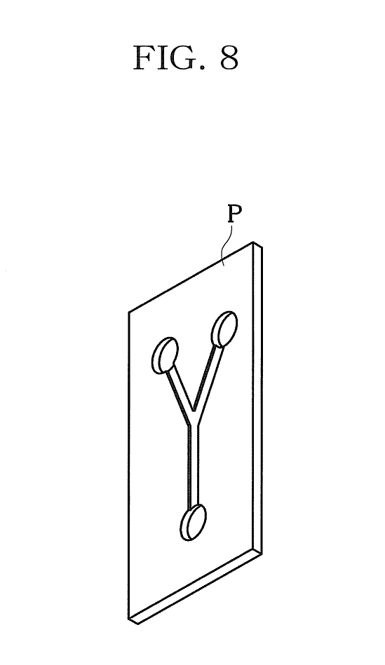

FIG. 7 illustrates an example of the shape of the microproduct P in which microdepressions are formed in the front side and which has not been cut at the gate G, and FIG. 8 illustrates an example of a microchannel formed in the microproduct P.

In FIGS. 7 and 8, the microstructure is illustrated to have a size significantly larger than the actual size for convenience of illustration.

The mold according to one embodiment of the invention is characterized in that a given clearance is provided between the frame 12 and the stamper member 13. Various modifications may be made as long as a given clearance is provided between the frame 12 and the stamper member 13.

A single or a plurality of first molds 10 and a single or a plurality of second molds 20 may be disposed in a master mold as split molds (nested molds).

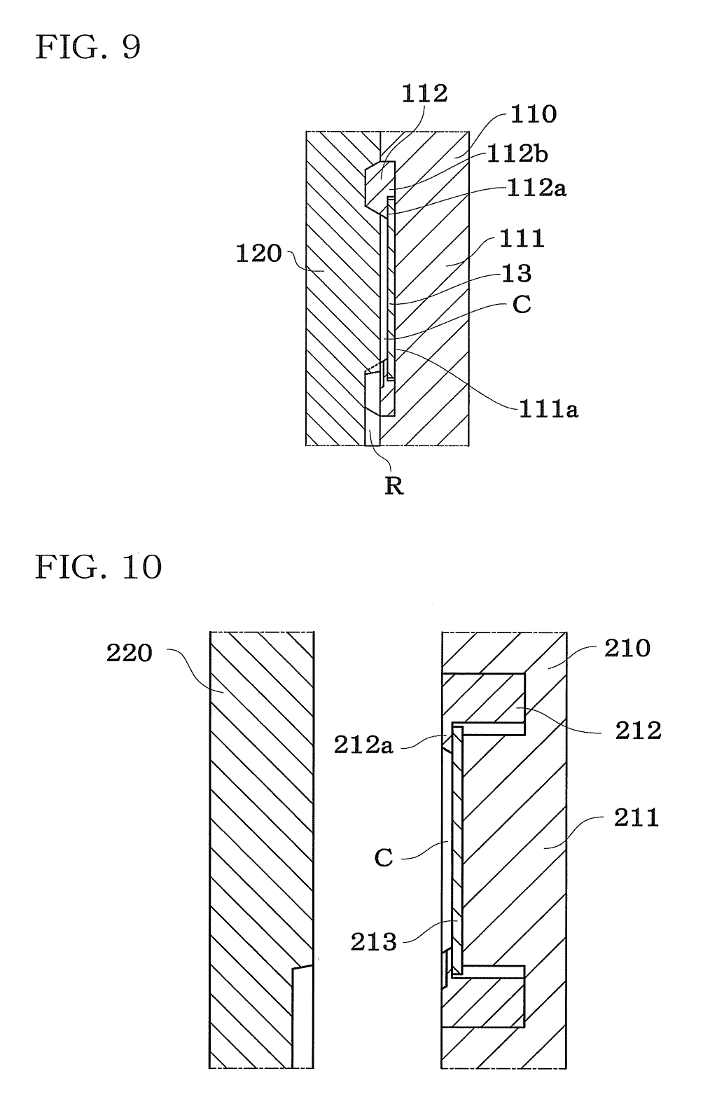

This modification may be applied to an example illustrated in FIG. 9, and may also be applied to other examples.

FIG. 9 illustrates an example in which the groove 11b illustrated in FIG. 1 is not formed in a base mold 111, and the bottom of a sidewall 112b of a frame 112 comes in contact with a flat side of the base mold 111.

FIG. 10 illustrates an example in which a frame 212 does not have a protrusion, and a front side restriction section 212a of the frame 212 is formed so that a second mold 220 can have a flat parting surface.

When the thickness of the product is 2 mm or less, the front side restriction section 12a of the frame 12 illustrated in FIG. 1 has a small thickness (i.e., has insufficient strength). Therefore, the front side restriction section may break during molding. When the thickness of the product is more than 3 mm, the front side restriction section has sufficient strength even if the parting surface of a second mold 220 is made flat (see FIG. 10). This makes it possible to implement mass production, and reduce the mold production cost.

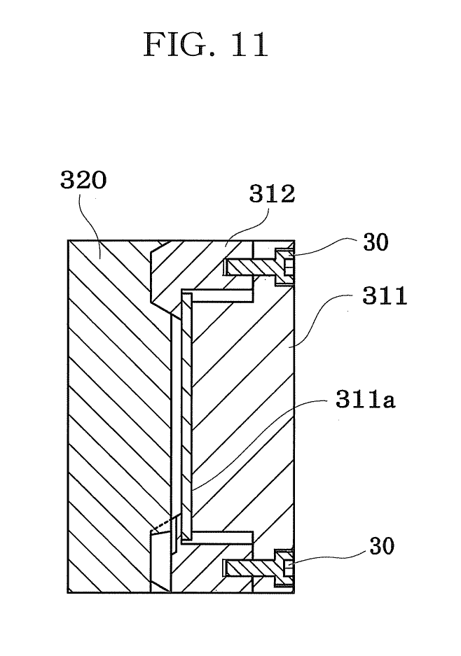

FIG. 11 illustrates an example in which a base mold 311 has a step-like protrusion section 311a (L-shaped groove), and a frame 312 is fastened using bolts 30 instead of inserting the frame 312 into the base mold 311.

The mold according to the embodiments of the invention may suitably be used when providing the stamper member in the mold, and producing a resin molded product to which the microstructure of the stamper member is transferred.

Therefore, the mold according to the embodiments of the invention may be applied to various fields (e.g., medical treatment, biochemistry, electrochemistry, electrical engineering, and analytical chemistry) that require a microproduct.

Although only some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention.

What is claimed is:

1. A mold for producing a microproduct comprising:
a first mold on which a stamper member is disposed; and
a second mold that is disposed to be relatively opened and closed with respect to the first mold,
the first mold including a frame and a base mold,
a front side of the stamper member, the frame, and the second mold defining a cavity,
the base mold including a back side section that supports a back side of the stamper member,
the frame including a front side restriction section that is positioned opposite to a front side edge area of the stamper member, and a sidewall that is positioned opposite to a side of the stamper member, and
a given clearance being provided between the front side edge area of the stamper member and/or the front side restriction section of the frame or between the side of the stamper member and the sidewall of the frame.

2. The mold as defined in claim 1,
the back side section of the base mold of the first mold being a protrusion section that is surrounded by a groove, and
the sidewall of the frame being disposed in the groove so that a bottom of the sidewall comes in contact with a bottom of the groove.

3. The mold as defined in claim 1,
the stamper member being formed of a brittle material.

4. The mold as defined in claim 1,
the stamper member being a silicon stamper, a given microstructure being formed in a front side of the silicon stamper.

5. The mold as defined in claim 1,
the stamper member being an SOI wafer, a given microstructure being formed in a front side of the SOI wafer.

6. The mold as defined in claim 3,
a clearance between the front side edge area of the stamper member and the front side restriction section of the frame being 0.005 to 0.05 mm, and
a clearance between the side of the stamper member and the sidewall of the frame being 0.03 to 0.07 mm.

7. The mold as defined in claim 1,
the clearance being adjustable depending on properties of a resin molding material and molding conditions.

8. A method of producing a microproduct comprising performing injection molding or transfer molding using the mold as defined in claim 1 to produce a microproduct.

9. A method of producing a microproduct comprising injection-molding a resin material using the mold as defined in claim 1 to produce a microproduct, the resin material including polypropylene and a thermoplastic elastomer.
